(19) United States
(12) Patent Application Publication
(10) Pub. No.: US 2022/0256882 A1
(43) Pub. Date: Aug. 18, 2022

(54) SYSTEMS AND METHODS FOR MANUFACTURING GUMMY PUFFS

(71) Applicant: Roses Confections, LP, Canajoharie, NY (US)

(72) Inventors: Brent Meyer, Dallas, TX (US); Yaacov Afek, Englewood, NJ (US)

(73) Assignee: Roses Confections, LP, Canajoharie, NY (US)

(21) Appl. No.: 17/178,537

(22) Filed: Feb. 18, 2021

(51) Int. Cl. A23G 3/02

(52) U.S. Cl. CPC A23G 3/0226; A23G 3/0215

(57) ABSTRACT

The present invention provides a system and method for producing gummy puffs. The system and method involves utilizing specific raw materials with specific chemical properties, manipulating vapor pressures, a low temperature dehydration process, and continuous freezing and annealing to form the gummy puffs. The gummy puffs produced by the system are dehydrated and have lower moisture content and have enhanced taste and flavors.

### FIELD OF INVENTION

The invention relates to the field of candies, gummy candies, and confectioneries. More specifically, the present invention relates to a system for manufacturing gummy puffs and a method of manufacturing the same.

### BACKGROUND OF THE INVENTION

Confections are broadly divided into two categories: one is chocolate-based confections having chocolate as the primary constituent and other one is sugar-based confections having sugar as the primary ingredient. Examples of chocolate-based confections include chocolate-covered confections, chocolate-panned confections, chocolate bars, and chocolate-covered fruits, nuts, and cremes. Examples of sugar-based confections include nougats, fondants, caramels, toffees, jellies, chewing gum, and gummy candies.

Gummy candies are sugar-based confections. Gummy candies constitute a large class of confectionery products and are manufactured in a variety of shapes and textures. Gummy candy is popular among people as it is a sweet-tasting confectionary consisting typically of a gelling agent and a sweetener among other ingredients available in vibrant colors and adorable shapes. The gummy candies are so flexible that they can be easily molded into desired shapes, making it most versatile confection product ever. They are also a dietary supplement that a person can eat whenever he is hungry and low on energy requirements.

The ability to maintain consistency, adapt well known confections to new manufacturing techniques, or replace an unavailable ingredient on the fly is only possible with a basic understanding of how functional ingredients impact confections. Generally, the dissolved solids in candy determine how hard or soft the final product is. Chewy sweets contain around 90 to 95 percent soluble solids by weight, whereas jams and jellies (which are usually made from the same ingredients as chewy candy) contain 75 to 80 percent. The lower the sugar content—and thus the higher the water content—the softer the substance will be.

Thanks to modern ingredients, confectioners can play with the rules. For example, adding maltodextrin, a chainlike polysaccharide molecule made from links of glucose, allows confectioners to increase the soluble solids content so that the candy gets firmer without getting too sweet.

Introducing droplets of fat, often from butter or shortening, or fine air bubbles weakens the candy's rubbery matrix, usually softening the texture. Similar to how mayonnaise has a different texture from that of oil or vinegar alone, the same goes for chewy candy. The small droplets of fat or the air bubbles help make the mass softer and more pliable. They also change the flavor profile. Small differences in how these oils or air are incorporated can make one candy very different from another.

There are many apparatuses and machines available in the market for producing gummy candies. However, these apparatuses and machines that are available are incompetent and ineffective. The apparatus and machines available produce candies having low shelf life. Also, the gummy candies produced are fragile, can be broken easily, and lack stability. The prior art is also not capable of processing newly discovered ingredients due to limitations in their processing capabilities. Some examples of these types of machines have been described below.

US patent application US20150216199 provides a gummy based high protein content snack. The gummy snack is formed in the starch mogul. The finishing process includes drying or curing the gummy slurry-containing starch mold trays. The gummy snacks produced here are dried by a conventional drying process resulting in a confection with an incredibly high moisture content. As a result, the gummy based snacks are easily broken and lack stability.

Another US Patent, US20180103655, describes a system and a method for making multi-structure candy comprising a gummy center encapsulated by hard candy. An extrusion machine is used for making the same. The gummy candy prepared is cooled in two stages. The cooling involves freezing the gummy candy within the temperature range 115-120 Fahrenheit. Although, the cooling described here stabilizes the gummy candy to a certain extent and reduces the moisture level, the candy formed here is hard and has moisture encapsulated within the candy.

U.S. Pat. No. 3,483,000 provides a method of freeze drying gelatin desserts. Freezing is accomplished by conventional techniques or by evaporative cooling. The evaporative cooling involves applying a high vacuum to the chilled gelatin product and the resultant sublimation of moisture reduces the product temperature. Although, the evaporative cooling of the gelatin desserts explained here dries the gelatin reasonably, the process explained is an incompetent process for freeze drying any raw material other than gelatin-based desserts.

US patent application US20060240176 relates to a confectionery produced by freeze drying. The confectionery is freeze dried by way of freezing the confectionery; subsequently setting the drying pressure to 0.60 to 0.65 Torr; performing primary sublimation by drying the confectionary at a temperature of 25° C. to 40° C., for 3 to 4 hours; subsequently performing secondary sublimation by drying the confectionary at a temperature of 60° C. to 70° C. for 18 to 20 hours; and further performing tertiary sublimation by drying the confectionary at a temperature of 35° C. to 45° C. for 1.5 to 4.5 hours. Although, the patent provides a freeze-drying method for confectionary, but the patent still lacks a complete process of making confectionary including gummy candies or any process which would result in a puffed gummy candy.

Therefore, to overcome the shortcomings of the prior art, there is a need to provide an integrated and efficient system for manufacturing gummy puffs having low moisture content and capable of long-term storage. The gummy puffs produced must have a maximum fruit and flavor content.

### SUMMARY OF THE INVENTION

In accordance with the present invention, the disadvantages and limitations of the prior art are substantially avoided by providing a system for manufacturing gummy puffs. The system includes a gummy unit for making gummy candies. The gummy unit includes a compounding unit for grinding and mixing raw materials of the gummy puffs. In the preferred embodiment of the invention, the raw material is comprised primarily of pectin as its gelling agent.

Much of the prior art relies on gelatin to be the base gelling agent. However, the limitations of gelatin will not result in a gummy puff due to its inadequate chemical properties. Gelatin is a protein. It creates relatively strong gummy candies that are formed via protein strand associations which tangle and link together to form strong junctions. That lends the product a sturdy stretch but also a quality called thermoreversibility. That means that under certain conditions , the gel reverses and the product becomes liquid. Cool it down, and the product re-gels. While this phase shifting between liquid and solid is not an issue with traditional gummy candies, puffing of a gelatin based gummy candy is not possible with the prior art. In manipulating pressures and temperatures needed to puff the candy, gelatin based gummy candies would revert to their liquid states and not be able to “puff.”

Conversely utilizing pectin, in combination with the novel system disclosed herein will result in a novel gummy puff. Pectin is a carbohydrate called a polysaccharide that is present in the skin of fruits and vegetables, and most commercial pectin is sourced from apple or citrus. In addition to being more versatile than gelatin, it has the added benefit of being suitable for vegans and vegetarians. The chemical properties of pectin allow it to set a relatively high temperature, thus allowing the resulting gummy candy to be puffed prior to cooling and drying.

The gummy unit further includes a mogul unit for receiving raw materials from the compounding unit, for making molded gummy candies. The mogul unit includes a depositor module for receiving compounded and mixed raw materials from the compounding unit. The depositor module further includes a plurality of trays for collecting the compounded raw materials of the gummy puffs. The mogul unit further comprises a stacker unit for stacking the plurality of trays of the depositor module. The mogul unit further includes a starch buck unit for molding and removing excess starch from the molded gummy candy received from the depositor module. The mogul unit further comprises a stacker module for stacking the gummy candy received from the starch buck module. The mogul unit further comprises a cooling room for cooling the gummy candy received from the stacker module for some specific time period.

The system further includes a freeze-drying unit for producing dehydrated and freeze-dried gummy puffs from the gummy candies received from the gummy unit. The freeze-drying unit includes a puffing unit for preserving and puffing the gummy candy received from the cooling unit. The puffing unit is further connected to the stabilizing unit of the freeze-drying unit for stabilizing the gummy puffs. The stabilizing unit continuously freezes the gummy puffs followed by annealing the gummy puffs received from the puffing unit. The freeze-drying unit further includes a drying unit for drying the gummy puffs, thereby producing dehydrated and freeze-dried gummy puffs.

A primary objective of the present invention is to provide a system for producing gummy puffs that have low moisture content and capable of long-term storage, while still maintaining the shape of the gummy puffs.

An objective of the present invention is to provide a system for producing gummy puffs having enhanced taste and flavors.

Another objective of the present invention is to provide a system for producing gummy puffs that are dried by low temperature dehydration process involving continuous freezing followed by annealing the gummy puffs.

Yet another objective of the present invention is to provide a system for producing gummy puffs having increased shelf life.

A further objective of the present invention is to provide a system for producing freeze dried gummy puffs having intact shape throughout the freeze-drying process. Using traditional methods with traditional ingredients would not result in a puffed product. The chemical properties of pectin allow it to set a relatively high temperature, thus allowing the resulting gummy candy to be puffed prior to cooling and drying.

In one embodiment of the present invention, the compounding unit of the gummy unit includes multiple mixing tanks for mixing the raw materials of the gummy puffs. Each of the mixing tanks further includes a heating arrangement, a cooling arrangement, and a mixing arrangement for properly and appropriately blending the raw materials of the gummy puffs.

In another embodiment of the present invention, the depositor unit of the mogul machine includes a nozzle for delivering a pre-defined amount of the raw materials to the multiple trays of the depositor unit. The multiple trays move along one by one for receiving the raw materials from the nozzle. In an alternative embodiment of the present invention, the filing nozzle may also deliver a flavoring agent, a color, and other components for enhancing the taste and texture of the gummy puffs. The flavoring agents and the color may be added simultaneously depending on the type of candies and gummy puffs to be manufactured.

In one another embodiment of the present invention, the starch buck module includes a molding module for shaping the gummy puffs. The molding module further includes a board printer for imprinting the required shapes, names, and logos on the gummy puffs. In another embodiment of the present invention, the starch buck module further includes a starch removal unit for removing excess starch from the gummy puffs. In one embodiment of the present invention, the starch removal unit includes a metal sieve for removing the excess starch from the gummy puffs by vibrating the metal sieve. The starch removal unit further includes multiple oscillating brushes connected to the metal sieve for removing the leftover starch adhered on the gummy puffs. In alternative embodiment of the present invention, the starch removal unit is a pneumatic starch removal unit.

In one embodiment of the present invention, the puffing unit preserves the gummy puffs by a decrease in vapor pressure which also results in an increase in surface area of the gummy puffs.

In one another embodiment of the present invention, the stabilizing unit freezes the gummy puffs continuously within a temperature range of −50 C to −80 C. The stabilizing unit also performs annealing of the gummy puffs. Additionally, the stabilizing unit further restricts the formation of ice crystals in the gummy puffs.

In one embodiment of the present invention, the drying unit further includes a primary drying unit for sublimating water molecules within the gummy puffs at a pre-defined pressure and temperature. The drying unit further includes a secondary drying unit for disintegrating any physio-chemical interactions between the water molecules and the ice crystals.

In an alternative embodiment of the present invention, a system for manufacturing gummy puffs is disclosed. The system includes a gummy unit for making gummy candies. The gummy unit includes a grinder assembly for grinding raw material of gummy puffs. The gummy unit further includes multiple mixers for mixing the gummy puffs received from the grinder assembly.

The system further includes a mogul unit for making molded gummy candies from the raw material received from the multiple mixers. The mogul unit further includes multiple depositor modules for receiving the raw materials from multiple mixers. Each of the depositor modules includes a nozzle and multiple trays, the nozzle delivers predefined amount of the raw materials to the multiple trays as the trays are conveyed under the nozzle. The trays from the depositor module are then transferred to a starch buck module.

The starch buck module includes a molding module for shaping the gummy puffs. The molding module further includes a board printer for imprinting the required shapes, names, and logos on the gummy puffs. The starch buck module further includes a cover which is placed on the plurality of trays to receive the gummy candies from the depositor module. The gummy candies adhere to the surface of the cover. The starch buck module further includes multiple air jets to provide compressed air for removing the starch from the gummy candies adhered to the cover. The mogul unit further comprises a stacker module for stacking the gummy candies received from the starch buck module. The mogul unit further comprises a cooling room for cooling the gummy candies received from the stacker module for specific time period.

The system further includes a freeze-drying unit for producing dehydrated and freeze-dried gummy puffs received from the gummy unit. The freeze-drying unit includes a puffing unit for preserving the gummy candies received from the cooling unit. In one embodiment of the present invention, the puffing unit preserves the gummy puffs by decreasing the vapor pressure resulting in an increase in surface area of the gummy puffs.

The puffing unit is further connected to the stabilizing unit of the freeze-drying unit for stabilizing the gummy puffs. The stabilizing unit continuously freezes the gummy puffs followed by annealing the gummy puffs received from the puffing unit. In one another embodiment of the present invention, the stabilizing unit freezes the gummy puffs continuously within a temperature range of −50 C to −80 C. The stabilizing unit also anneals the gummy puffs. The stabilizing unit further restricts the formation of ice crystals in the gummy puffs.

The freeze-drying unit further includes a drying unit for drying the gummy puffs, thereby producing dehydrated and freeze-dried gummy puffs. In one embodiment of the present invention, the drying unit further includes a primary drying unit for sublimating water molecules within the gummy puffs at a pre-defined pressure and a temperature. The drying unit further includes a secondary drying unit for disintegrating any physio-chemical interactions between the water molecules and the ice crystals at a temperature lower than the temperature of the secondary drying unit.

The terms gummy puffs, gummy candies, and gummy candy can be used interchangeably.

Embodiments of the present invention may employ any or all of the exemplary aspects above. Those skilled in the art will further appreciate the above-noted features and advantages of the invention together with other important aspects thereof upon reading the detailed description that follows in conjunction with the drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

Embodiments of the invention are described with reference to the following drawings, wherein:

FIG. 1(a) illustrates a representative view of a system of producing gummy puffs;

FIG. 1(b) illustrates a representative view of an alternate system of producing gummy puffs;

FIG. 2 illustrates a view of a gummy unit of the system of producing gummy puffs;

FIG. 3 illustrates a plan view of a freeze-drying unit of the system of producing gummy puffs;

FIG. 4(a) illustrates a method of manufacturing gummy puff; and

FIG. 4(b) illustrates a method of manufacturing freeze dried gummy puff by using an alternate system.

### DETAILED DESCRIPTION OF THE DRAWINGS

The present invention provides a system for producing gummy puffs. The gummy puffs utilize pectin as its main raw ingredient and gelling agent and are dried by a low temperature dehydration process involving continuous freezing followed by annealing the gummy puffs. The gummy puffs have enhanced flavor, taste, and shelf life.

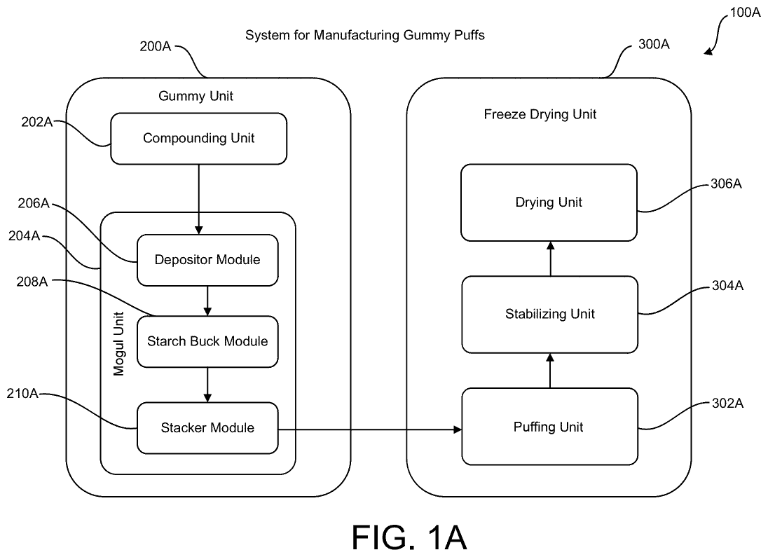

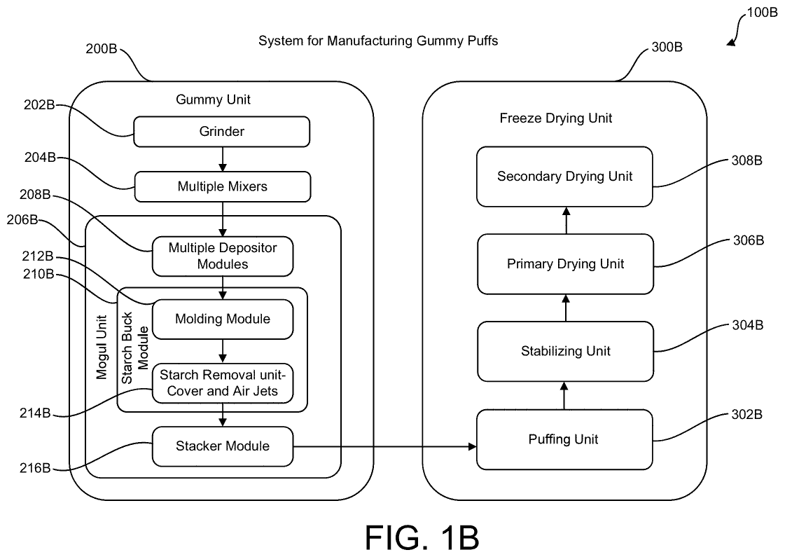

FIG. 1(a) illustrates a system for manufacturing gummy puffs 100. The gummy puffs include a gummy unit 200A for making gummy candies and a freeze drying unit 300A for freeze drying and puffing the gummy candies into gummy puffs. Firstly, the gummy unit 200A includes a compounding unit 202A for blending raw materials of the gummy puffs. The raw materials of the gummy puffs are selected on the basis of type of gummy candies or gummy puffs to be manufactured. Gummy candy or gummy puffs recipes are developed by experienced food technologists and chemists. By blending together different ingredients of the gummy puffs as approved by food technologists and chemists, they can control the various characteristics of gummy candy, such as texture, taste, and appearance. The main ingredients include water, a gelling agent, sweeteners, flavors, corn syrup, citric acids, starch and other ingredients selected depending upon the type of candies and jellies to be manufactured.

Much of the prior art relies on gelatin to be the base gelling agent. However, the limitations of gelatin will not result in a gummy puff due to its inadequate chemical properties. Gelatin is a protein. It creates relatively strong gummy candies that are formed via protein strand associations which tangle and link together to form strong junctions. That lends the product a sturdy stretch but also a quality called thermoreversibility. That means that in high temperatures, the gel reverses and the product becomes liquid. Cool it down, and the product re-gels. While this phase shifting between liquid and solid is not an issue with traditional gummy candies, puffing of a gelatin based gummy candy is not possible with the prior art. In manipulating pressures and temperatures needed to puff the candy, gelatin based gummy candies would revert to their liquid states and not be able to “puff” or retain its molded shape.

Conversely utilizing pectin, in combination with the novel system disclosed herein will result in a novel gummy puff. Pectin is a carbohydrate called a polysaccharide that is present in the skin of fruits and vegetables, and most commercial pectin is sourced from apple or citrus. In addition to being more versatile than gelatin, it has the added benefit of being suitable for vegans and vegetarians. The chemical properties of pectin allow it to set a relatively high temperature, thus allowing the resulting gummy candy to be puffed prior to cooling and drying.

The compounding unit 202A includes multiple mixing tanks for mixing the raw materials of the gummy puffs. The mixing tank further includes a heating arrangement, a mixing arrangement, and a cooling arrangement for properly blending appropriate amount of the raw materials of the gummy puffs. The mixing arrangement includes multiple blades for mixing the raw materials of the gummy puffs. The blended raw materials are further transferred to a mogul unit 204A for making gummy candies. As food quality is a subject of increasing concern, a quality check of the gummy candies may be required. The blended raw materials can be transferred to a quality check unit or inspection unit to carry out fast and reliable quality testing of the gummy candies.

After the raw materials of the gummy puffs are blended, the blended raw materials from the compounding unit 202A are transferred to a depositor module 206A of the mogul unit 204A for further processing. The depositor module 206A includes multiple trays for collecting the compounded and blended raw materials of the gummy puffs. The shape of the trays may be selected on the basis of shape of the gummy puffs or the gummy candy to be made. The shape of the trays may be square, rectangular, circular, trapezium, bear shape, snake shape, or any other shape depending upon the shape of the gummy puffs to be manufactured.

Each tray contains starch at base of the same. The starch may be deposited as coating or a layer at the base. Alternatively, the starch may also be added in solid form in the trays. The starch performs three main functions: First, the starch holds the gummy candy in place during cooling, settling, and drying processes. Second, the starch prevents the gummy candy from sticking to the trays or the candy molds, thereby allowing easy removal from the trays. Third, the starch absorbs moisture from the gummy candies, thereby providing the proper texture to the gummy puffs.

The depositor module 206A of the mogul machine includes a nozzle for delivering a pre-defined amount of the raw materials to the multiple trays of the depositor module 206A. The multiple trays move along one by one for receiving the raw materials from the nozzle of the depositor module 206A. In alternative embodiment of the present invention, the nozzle also delivers a flavoring agent, a color, and other components for enhancing the taste and texture of the gummy puffs. The flavoring agents and the color may be added simultaneously depending on the type of candies and gummy puffs to be manufactured. The flavoring agents may be a fruit flavor, sour flavor, sweet flavor, or any desirable flavor may be added depending upon the type of gummy puffs to be manufactured. The colors may be any colors such as blue, pink, red, or any other color that attract kids or the people. The blended raw materials filled trays are further transferred to a starch buck module 208A for further processing.

After the blended raw materials settle in the trays, the blended raw materials filled trays are transferred to a molding module of the starch buck module 208A for providing required shapes to the gummy puffs. The molding module includes a board printer for imprinting the required shapes, names, and logos on the gummy puffs. The blended raw materials filled trays are placed over a table in the molding module, thereby the board printer imprints shapes on the gummy puffs. The imprinting shapes may be bear, snake, dinosaurs, rings, frogs, bottles, circular, rectangular, square, tile, or any other desirable shapes depending upon type of gummy candy or gummy puffs to be manufactured. Names and logos of the company may also be imprinted on top of the gummy puffs showing brand name of the companies.

After the gummy candies are molded into their desired shapes, the filled trays are transferred to a starch removal unit of the starch buck module 208A for removing excess starch from the gummy candies. The starch removal unit includes a metal sieve for removing the excess starch from the gummy candies. The vibrating action of the metal sieve removes all the excess starch from the gummy candies. The multiple oscillating brushes connected to the metal sieve removes leftover starch adhered on the gummy candies.

After the excess starch is removed from the gummy candies, the starch free gummy candies are transferred to a stacker module 210A, the gummy candies received from the starch removal unit is stacked in the stacking module of the mogul unit. The stacker module 210A comprises a cooling room for cooling the gummy candies received from the stacker module 210A for a specific time period. The cooling room stores the gummy candies for cooling the gummy candies and further storing the gummy candies till the gummy candies are transferred for further processing.

In one embodiment, the cooling room stores the gummy candies for 24 hours.

After the gummy candies are cooled for a specific time period, the gummy candies are transferred to a freeze drying unit 300A for producing dehydrated and freeze-dried gummy puffs. The freeze drying unit 300A includes a puffing unit 302A for preserving the gummy candies received from the cooling unit. The puffing unit 302A preserves the gummy puffs by decreasing the vapor pressure which results in an increase in surface area of the gummy puffs.

After the gummy candies are puffed, the gummy puffs are transferred to a stabilizing unit 304A of the freeze drying unit 300A for stabilizing the gummy puffs. The stabilizing unit 304A continuously freezes the gummy puffs followed by annealing the gummy puffs received from the pre-treatment unit 302A. The stabilizing unit 304 performs freezing the gummy puffs continuously at freezing temperatures. More specifically, the temperature range of freezing in the stabilizing unit 304A is −50 C to −80 C. The stabilizing unit 304A further performs annealing of the gummy puffs. The stabilizing unit 304A further restricts the formation of ice crystals in the gummy puffs. The gummy puffs are stabilized in the stabilizing unit 304A of the freeze drying unit 300A.

After the gummy puffs are stabilized, the stabilized gummy puffs are transferred to a drying unit 306A for drying, thereby producing gummy puffs. The gummy puffs are transferred to a primary drying unit for sublimating water molecules within the gummy puffs at a predefined pressure and at a first temperature. The primary drying includes a condenser chamber allowing sublimation of the water molecules. Alternatively, the primary drying unit may include a condenser plate for sublimating the water molecules. The pressure is controlled by applying partial vacuum through a vacuum pump, the partial vacuum speed up the sublimation process, thereby drying the gummy puffs effectively. The first temperature is calculated on the basis of latent heat of sublimation of the water molecules.

After the gummy puffs are dried in the primary drying unit 306A at first temperature, the gummy puffs transferred to a secondary drying unit for further dehydrating the gummy puffs. The secondary drying unit is at a second temperature, disintegrating any physio-chemical interactions between the water molecules and the ice crystals remaining on the gummy puffs. The second temperature is lower than that of the first temperature. More specifically, the temperature of the secondary drying unit is 0 degree Celsius. The secondary drying unit produces completely dehydrated gummy puffs having low residual water content. More specifically, the residual water content in the dehydrated gummy puffs is around 1% to 4%.

The gummy puffs are then transferred to a packaging station for packaging the gummy puffs. The packaging unit comprises multiple trays for arranging the gummy puffs. The gummy puffs are further decorated and packed in the desired packaging accordingly.

Exemplary gummy puffs include gummy bears, gummy worms, gummy frogs, gummy hamburgers, gummy cherries, gummy soda bottles, gummy sharks, gummy lobsters, gummy watermelons, gummy octopuses, gummy apples, gummy peaches, gummy oranges, fizzy chip candies, strawberry belt candies, apple belt candies, and all type of gummy candies known in the prior art.

FIG. 1(b) illustrates an alternate embodiment of a system for manufacturing gummy puffs 100B. The system includes a gummy unit 200B for making the gummy candies and a freeze drying unit 300B for puffing and freeze drying the gummy candies thereby producing gummy puffs. First, the gummy unit 200B includes a compounding unit for blending raw materials of the gummy puffs. The raw materials of the gummy puffs are selected on the basis of type of gummy candies or gummy puffs to be manufactured. Gummy candy or gummy puffs recipes are developed by experienced food technologists and chemists. By blending together different ingredients of the gummy puffs as approved by food technologists and chemists, they can control the various characteristics of gummy candy, such as texture, taste, and appearance. The main ingredients include water, a gelling agent, sweeteners, flavors, corn syrup, citric acids, starch and other ingredients selected depending upon the type of candies and jellies to be manufactured.

Much of the prior art relies on gelatin to be the base gelling agent. However, the limitations of gelatin will not result in a gummy puff due to its inadequate chemical properties. Gelatin is a protein. It creates relatively strong gummy candies that are formed via protein strand associations which tangle and link together to form strong junctions. That lends the product a sturdy stretch but also a quality called thermoreversibility. That means that in high temperatures, the gel reverses and the product becomes liquid. Cool it down, and the product re-gels. While this phase shifting between liquid and solid is not an issue with traditional gummy candies, puffing of a gelatin based gummy candy is not possible with the prior art. In manipulating pressures and temperatures needed to puff the candy, gelatin based gummy candies would revert to their liquid states and not be able to “puff.”

Conversely utilizing pectin, in combination with the novel system disclosed herein will result in a novel gummy puff. Pectin is a carbohydrate called a polysaccharide that is present in the skin of fruits and vegetables, and most commercial pectin is sourced from apple or citrus. In addition to being more versatile than gelatin, it has the added benefit of being suitable for vegans and vegetarians. The chemical properties of pectin allow it to set a relatively high temperature, thus allowing the resulting gummy candy to be puffed prior to cooling and drying.

As food quality is a subject of increasing concern, thereby the quality check of the gummy puffs is required. The blended raw materials are further transferred to a quality check unit or inspection unit to carry out fast and reliable quality testing of the gummy puffs from the compounding unit.

The compounding unit includes a grinder 202B and multiple mixers 204B for mixing the raw materials of the gummy puffs. The mixing tank further includes a heating arrangement, a mixing arrangement, and a cooling arrangement for properly blending appropriate amount of the raw materials of the gummy puffs. The mixing arrangement includes multiple blades for mixing the raw materials of the gummy puffs. The blended raw materials are further transferred to a mogul unit 206B for making the gummy puffs. Alternatively, the compounding unit may also include a grinder for grinding the raw materials of the gummy puffs.

After the raw materials of the puffs are blended, the blended raw materials from the compounding unit are transferred to a depositor module 208B of the mogul unit 206B for further processing. The depositor module 208B includes multiple trays for collecting the compounded and blended raw materials of the gummy puffs. The shape of the trays may be selected on the basis of shape of the gummy puffs or the gummy candy to be made. The shape of the trays may be square, rectangular, circular, trapezium, bear shape, snake shape, or any other shape depending upon the shape of the gummy puffs to be manufactured.

Each tray contains starch at base of the same. The starch may be deposited as coating or a layer at the base. Alternatively, the starch may also be added in solid form in the trays. The starch performs three main functions: First, the starch holds the raw materials in place during cooling, settling, and drying processes. Second, the starch prevents the gummy candy from sticking to the trays or the candy molds, thereby allowing easy removal of the gummy candy from the trays. Lastly, the starch absorbs moisture from the gummy candy, which provides a proper texture to the gummy puffs.

The depositor unit of the mogul machine includes a nozzle for delivering a pre-defined amount of the raw materials to the multiple trays of the depositor unit. The multiple trays move along one by one for receiving the raw materials from the nozzle of the depositor unit. In alternative embodiment of the present invention, the nozzle also delivers a flavoring agent, a color, and other components for enhancing the taste and texture of the gummy puffs. The flavoring agents and the color may be added simultaneously depending on the type of candies and gummy puffs to be manufactured. The flavoring agents may be a fruit flavor, sour flavor, sweet flavor, and any desirable flavors may be added depending upon the type of gummy puffs to be manufactured. The colors may be any colors such as blue, pink, red or any other color that attract consumers. The blended raw materials filled trays are further transferred to a starch buck module 210B for further processing.

After the blended raw materials settle in the trays, the blended raw materials filled trays are transferred to a molding module 212B of the starch buck module 210B for providing required shapes to the gummy puffs. The molding module 212B includes a board printer for imprinting the required shapes, names and logos on the gummy puffs. The imprinting shapes may be bear, snake, dinosaurs, rings, frogs, bottles, circular, rectangular, square, tile, or any other desirable shapes depending upon type of gummy puffs to be manufactured. Names and logos may also be imprinted on top of the gummy puffs if desired.

After the raw materials are molded into desired shapes, the molded raw material filled trays are transferred to a starch removal unit of the starch buck module 210B for removing excess starch from the gummy puffs. The starch removal unit includes a metal sieve for removing the excess starch from the gummy puffs. The vibrating action of the metal sieve removes all the excess starch from the gummy puffs. The multiple oscillating brushes connected to the metal sieve removes leftover starch adhered on the gummy puffs.

The starch free gummy candies are further transferred to a stacker module 216B for further processing. After the excess starch removed from the gummy puffs, the starch free gummy candies are automatically transferred to a stacker module 216B, the gummy candies received from the starch removal unit are stacked in the stacking module of the mogul unit 206B. The stacker module 216B comprises a cooling room for cooling the gummy puffs received from the stacker module 216B for specific time period. The cooling room stores the gummy puffs for cooling the gummy puffs and further storing the gummy puffs till the gummy puffs are transferred for further processing. In one embodiment, the cooling room stores the gummy candies for 24 hours.

After the gummy candies are cooled for a specific time period, the gummy candies are transferred to a freeze drying unit 300B for producing dehydrated and freeze-dried gummy puffs. The freeze drying unit 300B includes a puffing unit 302B for preserving the gummy puffs received from the cooling unit. The pre-treatment unit 302B preserves the gummy puffs by a decrease in vapor pressure thereby increasing the surface area of the gummy puffs.

After the gummy candies are puffed, the gummy puffs are transferred to a stabilizing unit 304B of the freeze drying unit 300B for stabilizing the gummy puffs. The stabilizing unit 304B performs freezing the gummy puffs continuously at freezing temperatures. More specifically, the temperature range of freezing in the stabilizing unit 304B is −50 C to −80 C. The stabilizing unit 304B further performs annealing of the gummy puffs. The stabilizing unit 304B further restricts the formation of ice crystals in the gummy puffs. The gummy puffs are stabilized in the stabilizing unit 304B of the freeze drying unit 300B.

After the gummy puffs are stabilized, the stabilized gummy puffs are transferred to a drying unit for drying, thereby producing dehydrated gummy puffs. The gummy puffs are first transferred to a primary drying unit 306B for sublimating water molecules within the gummy puffs at a predefined pressure and at a first temperature. The primary drying includes a condenser chamber allowing sublimation of the water molecules. Alternatively, the primary drying unit 306B may include a condenser plate for sublimating the water molecules. The pressure is controlled by applying partial vacuum, the partial vacuum speed up the sublimation process, thereby drying the gummy puffs effectively. The first temperature is calculated on the basis of latent heat of sublimation of the water molecules.

After the gummy puffs are dried in the primary drying unit 306B at first temperature, the gummy puffs automatically transferred to a secondary drying unit 308B for further dehydrating the gummy puffs. The secondary drying unit 308B is at second temperature, disintegrates any physio-chemical interactions between the water molecules and the ice crystals on the gummy puffs. The second temperature is lower than that of the first temperature. More specifically, the temperature of the secondary drying unit 308B is 0 degree Celsius. The secondary drying unit 308B produces completely dehydrated gummy puffs having low residual water content. More specifically, the residual water content in the dehydrated gummy puffs is around 1% to 4%.

The dehydrated gummy puffs are then transferred to a packaging station for packaging the gummy puffs. The packaging unit comprises multiple trays for arranging the gummy puffs. The gummy puffs are further decorated and packed in the desired packaging accordingly.

Exemplary gummy puffs include gummy bears, gummy worms, gummy frogs, gummy hamburgers, gummy cherries, gummy soda bottles, gummy sharks, gummy lobsters, gummy watermelons, gummy octopuses, gummy apples, gummy peaches, gummy oranges, fizzy chip candies, strawberry belt candies, apple belt candies, and all type of gummy candies known in the prior art.

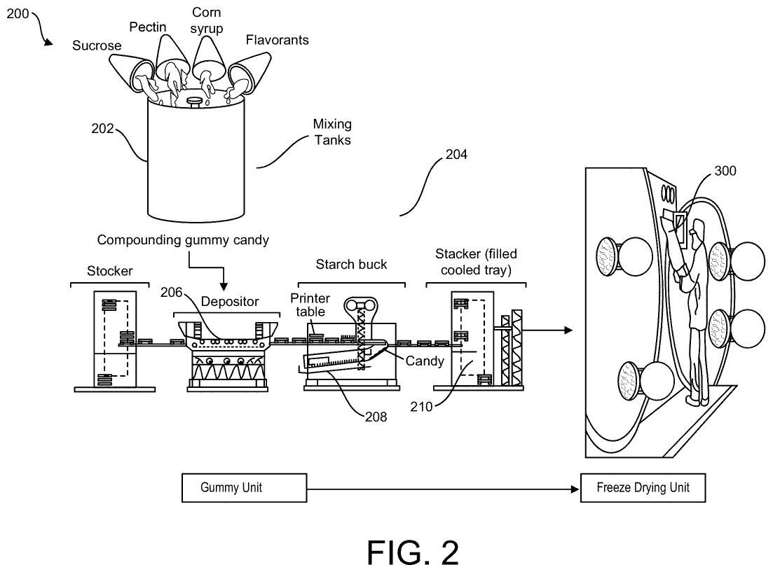

FIG. 2 illustrates a gummy unit (200) of the system of manufacturing the gummy puffs. The gummy unit (200) includes a grinder (202) for grinding the raw materials of the gummy puffs. The grinder (202B) includes a grinding assembly for pulverizing the raw materials of the gummy puffs in the fine materials. The raw materials of the gummy puffs are selected on the basis of type of gummy candies or gummy puffs to be manufactured. Gummy candy or gummy puffs recipes are developed by experienced food technologists and chemists. By blending together different ingredients of the gummy puffs as approved by the food technologists and the chemists, the food chemists or food technologists can control the various characteristics of gummy candy, such as texture, taste, and appearance. The main ingredients include water, a gelling agent, sweeteners, flavors, corn syrup, citric acids, starch and other ingredients selected depending upon the type of candies, jellies to be manufactured.

Much of the prior art relies on gelatin to be the base gelling agent. However, the limitations of gelatin will not result in a gummy puff due to its inadequate chemical properties. Gelatin is a protein. It creates relatively strong gummy candies that are formed via protein strand associations which tangle and link together to form strong junctions. That lends the product a sturdy stretch but also a quality called thermoreversibility. That means that in high temperatures, the gel reverses and the product becomes liquid. Cool it down, and the product re-gels. While this phase shifting between liquid and solid is not an issue with traditional gummy candies, puffing of a gelatin based gummy candy is not possible with the prior art. In manipulating pressures and temperatures needed to puff the candy, gelatin based gummy candies would revert to their liquid states and not be able to “puff.”

Conversely utilizing pectin, in combination with the novel system disclosed herein will result in a novel gummy puff. Pectin is a carbohydrate called a polysaccharide that is present in the skin of fruits and vegetables, and most commercial pectin is sourced from apple or citrus. In addition to being more versatile than gelatin, it has the added benefit of being suitable for vegans and vegetarians. The chemical properties of pectin allow it to set a relatively high temperature, thus allowing the resulting gummy candy to be puffed prior to cooling and drying.

The gummy unit (200) further includes multiple mixers (202) for mixing the compounded raw materials received from the grinder assembly. Each of the mixers (202) includes a heating arrangement, a mixing arrangement, and a cooling arrangement for properly blending appropriate amount of the raw materials of the gummy puffs. The temperature of the heating arrangement and the cooling arrangement can be adjusted as per requirements of the type of gummy puffs to be manufactured. As food quality is a subject of increasing concern, thereby the quality check of the gummy puffs is required. The blended raw materials are further transferred to a quality check unit or inspection unit to carry out fast and reliable quality testing of the gummy puffs.

The blended raw materials are further transferred to a mogul unit (204) for making the gummy puffs. The blended raw material is firstly transferred to multiple depositor unit (206) of the mogul unit (204). Each of the depositor modules (206) includes multiple trays for collecting the compounded and blended raw materials of the gummy puffs. The shape of the trays may be selected on the basis of shape of the gummy puffs or the gummy candy to be made. The shape of the trays may be square, rectangular, circular, trapezium, bear shape, snake shape, bear-shaped molds, worm-shaped molds, dot-shaped roughly a rounded, truncated cone, rounded cylinder molds, pill-shaped molds, fish-shaped molds, ring-shaped molds, fruit-shaped molds, and the like.

Each tray contains starch at base of the same. The starch may be deposited as coating or a layer at the base. Alternatively, the starch may also be added in solid form in the trays. The depositor unit (206) of the mogul module (204) includes a nozzle for delivering a pre-defined amount of the raw materials to the multiple trays of the depositor unit (206). The multiple trays move along one by one for receiving the raw materials from the nozzle of the depositor unit (206). In alternative embodiment of the present invention, the nozzle also delivers a flavoring agent, a color, and other components for enhancing the taste and texture of the gummy puffs. The flavoring agents, acids, and the color may be added simultaneously depending on the type of candies and gummy puffs to be manufactured. The flavoring agents may be a fruit flavor, sour flavor, sweet flavor, and any desirable flavors may be added depending upon the type of gummy puffs to be manufactured. The colors may be any colors such as blue, pink, red, or any other color that attracts consumers. The blended raw materials filled trays are further transferred to a starch buck module for further processing. The acids may be a citric acid.

After the blended raw materials are settled in the trays, the blended raw materials filled trays are transferred to a molding module of the starch buck module (208) for providing required shapes to the gummy puffs. The molding module includes a board printer for imprinting the required shapes, names, and logos on the gummy puffs. The imprinting shapes may be bear, snake, dinosaurs, rings, frogs, bottles, circular, rectangular, square, tile, or any other desirable shapes depending upon type of gummy puffs to be manufactured. Names and logos may also be imprinted on top of the gummy puffs.

After the raw materials are molded into their desired shapes, the molded raw material filled trays are transferred to a starch removal unit of the starch buck module (208) for removing excess starch from the gummy puffs. The starch removal unit (208) is a pneumatic starch removal unit. The starch removal unit includes a cover which is placed on multiple trays to receive the gummy puffs. The cover gets tightly fitted on the multiple trays, thereby the gummy puffs adhere to the surface of the cover in an ordered array. The cover further inverted to remove the starch from the trays and to remove any leftover starch fully from the gummy puffs, compressed air is flowed or sprayed through the multiple air jets to the gummy puffs adhered to the cover.

After the excess starch removed from the gummy candies, the excess starch and candy particles collected in the starch removal unit is transferred to a metal sieve for filtering the excess starch from the solid candy particles, thereby collecting and transferring the excess starch removed in the starch removal unit is further transferred to a re-circulating starch conditioning system for reconditioning the excess starch. The re-circulating starch conditioning system includes a drying unit for drying the starch. The drying unit is a drier which circulates hot air for drying starch collected from the starch removal unit. The dried starch is further transferred to a cooling unit for reconditioning the starch. The cooling unit includes multiple air jets supplying cool air, thereby cooling and reconditioning the starch. The reconditioned starch is further transferred to the depositor module for reusing the reconditioned starch received from the starch removal unit via the conveyor belt. The reconditioned starch is further transferred to the empty multiple trays of the depositor module, thereby leveling the starch for further use. The starch free gummy puffs are further transferred to a stacker module for further processing and then transferred to a freeze-drying unit for further processing.

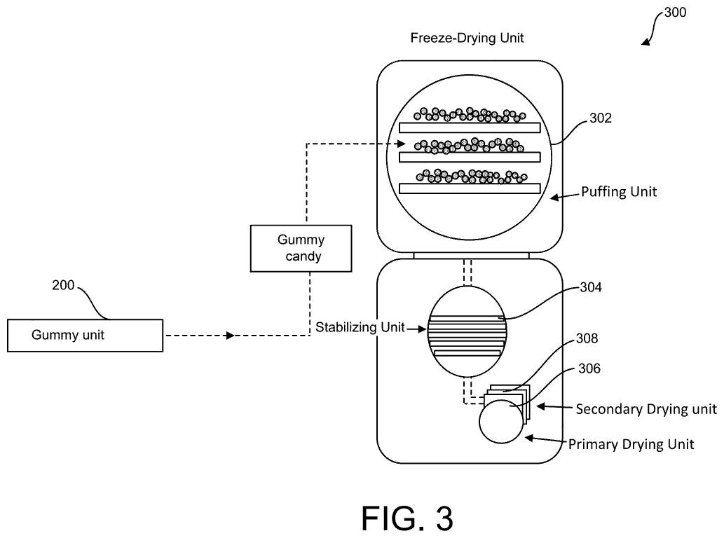

FIG. 3 illustrates a freeze-drying unit (300) of the system of manufacturing the gummy puffs. The freeze-drying unit (300) performs a low temperature dehydration process for drying the gummy puffs involving freezing the product, lowering pressure, then removing the ice by sublimation.

After the gummy candies are cooled for a specific time period, the gummy puffs are transferred to a freeze drying unit (300) for gummy puffs received from the gummy unit. The freeze-drying unit (300) includes a puffing unit (302) for puffing the gummy candies. The puffing unit (302) puffs the gummy candies by decreasing the vapor pressure resulting in an increase in surface area of the gummy candies.

After the gummy candies are pre-treated, they are transferred to a stabilizing unit (304) of the freeze-drying unit (300) for stabilizing the gummy puffs. The stabilizing unit (304) continuously freeze the gummy puffs followed by annealing the gummy puffs received from the pre-treatment unit. The stabilizing unit (304) performs freezing the gummy puffs continuously at low temperatures. More specifically, the temperature range of freezing in the stabilizing unit (304) is −50 C to −80 C. The stabilizing unit (304) further performs annealing of the gummy puffs. The stabilizing unit (304) further restricts the formation of ice crystals in the gummy puffs. The gummy puffs are stabilized in the stabilizing unit (304) of the freeze-drying unit (300).

After, the gummy puffs are stabilized, the stabilized gummy puffs are transferred to a drying unit for drying, thereby producing dehydrated gummy puffs. The gummy puffs are transferred to a primary drying unit (306) for sublimating water molecules within the gummy puffs at a predefined pressure and at a first temperature. The primary drying unit (306) includes a vacuum pump for creating partial vacuum for speeding sublimation of the water molecules. The primary drying includes a condenser chamber allowing sublimation of the water molecules. Alternatively, the primary drying unit (306) may include a condenser plate for sublimating the water molecules. The pressure is controlled by applying partial vacuum created by the vacuum pump, the partial vacuum speed up the sublimation process, thereby drying the gummy puffs effectively. The first temperature is calculated on the basis of latent heat of sublimation of the water molecules.

After the gummy puffs are dried in the primary drying unit (306) at first temperature, the gummy puffs transferred to a secondary drying unit (308) for further dehydrating the gummy puffs. The secondary drying unit (308) is at second temperature, disintegrates any physio-chemical interactions between the water molecules and the ice crystals on the gummy puffs. The second temperature is lower than that of the first temperature. More specifically, the temperature of the secondary drying unit (308) is 0 degree Celsius. The secondary drying unit (308) produces completely dehydrated gummy puffs having low residual water content. More specifically, the residual water content in the dehydrated gummy puffs is around 1% to 4%.

After the freeze drying of the gummy puffs is completed, the vacuum is usually broken by applying the inert gas. More specifically, the gas used for breaking vacuum is nitrogen gas. The gummy puffs are further sent to a packaging unit for sealing and packing the gummy puffs.

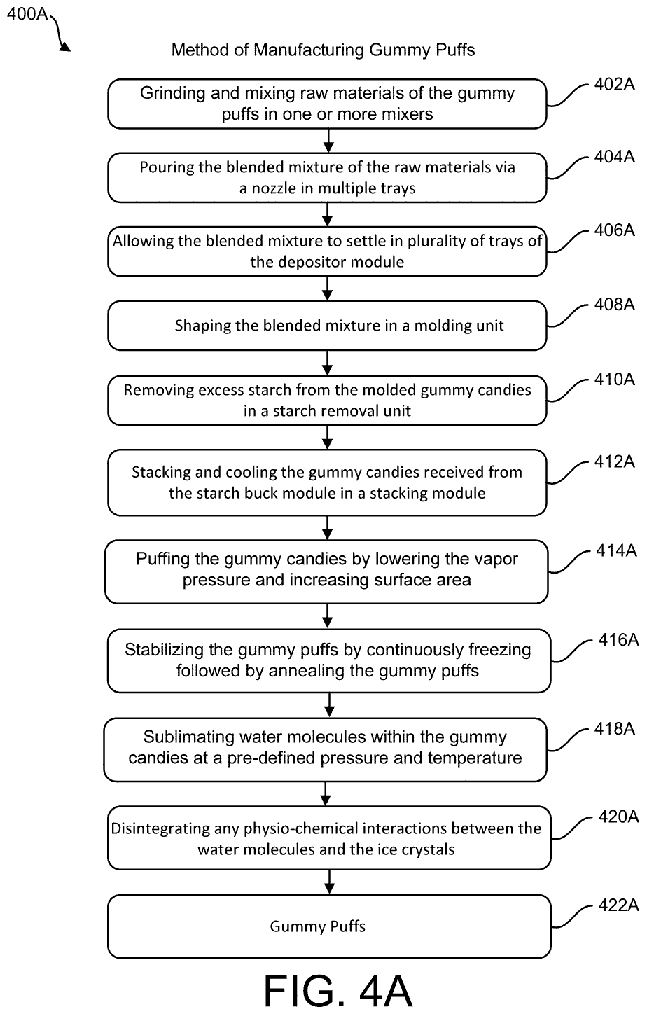

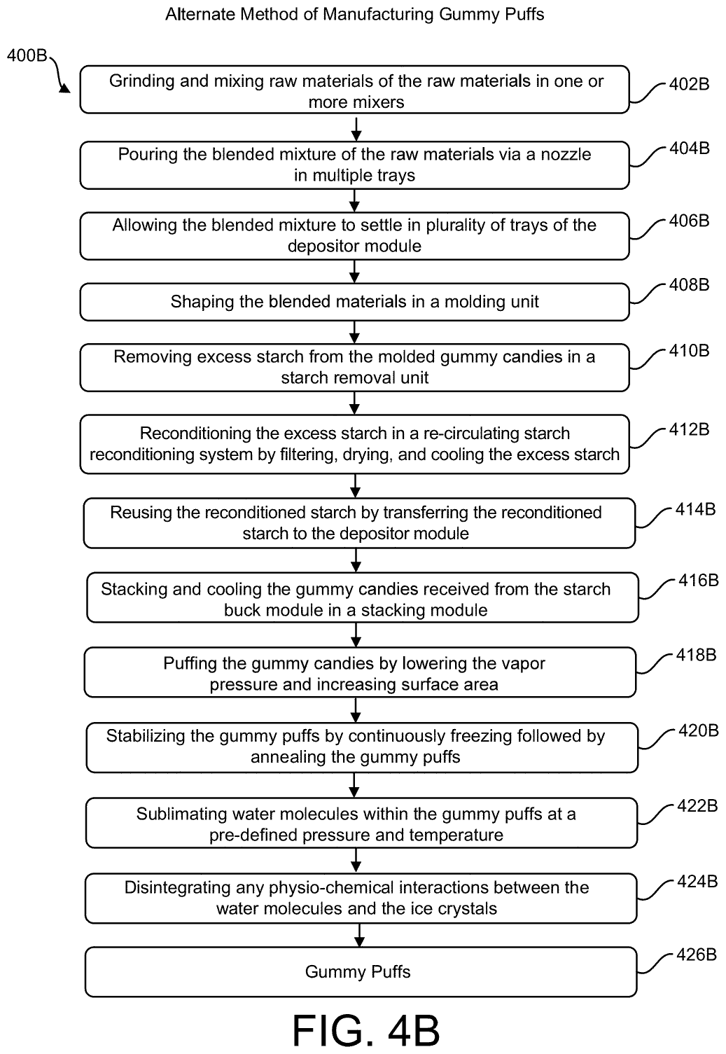

FIG. 4(a) illustrates a method for manufacturing gummy puffs. The method of manufacturing gummy puffs involves following steps.

At step 402A, the step includes grinding of raw materials of the gummy puffs. The grinding of raw materials is performed in a grinding assembly. The raw materials of the gummy puffs include water, a gelling agent, sweeteners, flavors, corn syrup, citric acids, starch and other materials selected depending upon the type of candies, jellies and puffs to be manufactured. By blending different ingredients of the gummy puffs as approved by the food technologists and the chemists, the food chemists or food technologists can control the various characteristics of gummy candy, such as texture, taste, and appearance.

Much of the prior art relies on gelatin to be the base gelling agent. However, the limitations of gelatin will not result in a gummy puff due to its inadequate chemical properties. Gelatin is a protein. It creates relatively strong gummy candies that are formed via protein strand associations which tangle and link together to form strong junctions. That lends the product a sturdy stretch but also a quality called thermoreversibility. That means that in high temperatures, the gel reverses and the product becomes liquid. Cool it down, and the product re-gels. While this phase shifting between liquid and solid is not an issue with traditional gummy candies, puffing of a gelatin based gummy candy is not possible with the prior art. In manipulating pressures and temperatures needed to puff the candy, gelatin based gummy candies would revert to their liquid states and not be able to “puff.”

Conversely utilizing pectin, in combination with the novel system disclosed herein will result in a novel gummy puff. Pectin is a carbohydrate called a polysaccharide that is present in the skin of fruits and vegetables, and most commercial pectin is sourced from apple or citrus. In addition to being more versatile than gelatin, it has the added benefit of being suitable for vegans and vegetarians. The chemical properties of pectin allow it to set a relatively high temperature, thus allowing the resulting gummy candy to be puffed prior to cooling and drying.

The step also includes mixing of the grinded raw materials of the gummy puffs. The mixing of raw materials of the gummy puffs is performed by one or more mixers to form a blended mixture of the raw materials of the gummy puffs. Each of the mixers includes a heating arrangement, a mixing arrangement, and a cooling arrangement for properly blending appropriate amount of the raw materials of the gummy puffs. The temperature of the heating arrangement and the cooling arrangement can be adjusted as per requirements of the type of gummy puffs to be manufactured.

At step 404A, the step includes pouring the blended mixture of the raw materials via a nozzle in multiple trays of a depositor module received from the mixers. The nozzle delivers a pre-defined amount of the raw materials to the multiple trays of the depositor unit. The multiple trays are transferred one by one under the nozzle of the depositor unit.

At step 406A, the step includes allowing the blended mixture of the raw materials to settle in multiple trays of the depositor unit for a pre-defined time interval to form a blended mixture of the gummy puffs.

At step 408A, the step includes molding the raw materials in a molding module of a starch buck module received from the depositor module. After the blended raw materials settled in the trays, the blended raw material filled trays are transferred to a molding module of the starch buck module for forming required shapes to the gummy puffs. The method includes imprinting the required shapes, names, and logos on the gummy puffs by a board printer of the molding module.

At step 410A, the step includes removing excess starch from the molded gummy candies in a starch removal unit of the starch buck module. After the raw materials are molded into their desired shapes, the molded gummy candy filled trays are transferred to a starch removal unit of the starch buck module for removing excess starch from the gummy candies. The method includes transferring the molded gummy candy filled trays to a metal sieve for removing the excess starch deposited on the gummy candies. The sieving is performed by vibrating the metal sieve. The method further includes removing the leftover starch deposited on the gummy candies multiple oscillating brushes connected to the metal sieve.

At step 412A, the step includes stacking and cooling the gummy candies received from the starch buck module. After the excess starch removed from the molded gummy candies, the starch free gummy candies are transferred to a stacker module. The method includes stacking of the gummy candies received from the starch removal unit in the stacking module of the mogul unit. The method further includes cooling the stacked gummy candies transferring them to a cooling room for specific time period. The cooling room stores the gummy candies for cooling the gummy candies and storing the gummy candies until the gummy candies are transferred for further processing. In one embodiment, the cooling room stores the gummy candies for 24 hours.

At step 414A, the step includes puffing the cooled gummy candies received from the stacker module. After the gummy candies are cooled enough, the cooled gummy candies are transferred to a puffing unit for puffing the gummy candies. The method includes decreasing the vapor pressure resulting in an increase in surface area of the gummy candies.

At step 416A, the step includes stabilizing the gummy puffs by continuously freezing followed by annealing the gummy puffs received from the pre-treatment. After the gummy candies are puffed, the gummy puffs are transferred to a stabilizing unit for stabilizing the gummy puffs. The method includes continuous freezing of the gummy puffs at freezing temperatures. More specifically, the temperature range of freezing in the stabilizing unit is −50 C to −80 C. The method further includes annealing of the gummy puffs in the stabilizing unit for restricting formation of large ice crystals in the gummy puffs.

At step 418A, the step includes sublimation of the water molecules within the gummy puffs. After the gummy puffs are stabilized, the stabilized gummy puffs are transferred a primary drying unit for sublimating water molecules within the gummy puffs at a predefined pressure and at a first temperature. The first temperature is calculated on the basis of latent heat of sublimation of the water molecules.

At step 420A, the step includes disintegrating any physio-chemical interactions between the water molecules and the ice crystals to form completely dehydrated gummy puffs. After the gummy puffs are dried in the primary drying unit, the gummy puffs transferred to a secondary drying unit for further dehydrating of the gummy puffs. The method includes drying the gummy puffs at a second temperature to disintegrate any physio-chemical interactions between the water molecules and the ice crystals on the gummy puffs, thereby producing completely dehydrated and freeze-dried gummy puffs (422A).

FIG. 4(b) illustrates an alternate method for manufacturing gummy puffs. The method of manufacturing gummy puffs involves following steps.

At step 402B, the step includes grinding of raw materials of the gummy puffs. The grinding of raw materials is performed in a grinding assembly. The raw materials of the gummy puffs include water, a gelling agent, sweeteners, flavors, corn syrup, citric acids, starch, and other materials selected depending upon the type of candies, jellies, and puffs to be manufactured. By blending different ingredients of the gummy puffs as approved by the food technologists and the chemists, the food chemists or food technologists can control the various characteristics of gummy candy, such as texture, taste, and appearance.

The step also includes mixing of the grinded raw materials of the gummy puffs received from the grinding assembly. The mixing of raw materials of the gummy puffs is performed by one or more mixers to form a blended mixture of the raw materials of the gummy puffs. Each of the mixers includes a heating arrangement, a mixing arrangement, and a cooling arrangement for properly blending appropriate amount of the raw materials of the gummy puffs. The temperature of the heating arrangement and the cooling arrangement can be adjusted as per requirements of the type of gummy puffs to be manufactured.

At step 404B, the step includes pouring the blended mixture of the gummy puffs via a nozzle in multiple trays of a depositor module received from the mixers. The nozzle delivers a pre-defined amount of the raw materials to the multiple trays of the depositor unit.

At step 406B, the step includes allowing the blended mixture of the raw materials to settle in multiple trays of the depositor unit for a pre-defined time interval.

At step 408B, the step includes molding the raw materials in a molding module of a starch buck module received from the depositor module. After the blended raw materials are settled in the trays, the blended raw material filled trays are transferred to a molding module of the starch buck module for forming the required shapes of the gummy puffs. The method includes imprinting the required shapes, names, and logos on the gummy puffs by using a board printer of the molding module.

At step 410B, the step includes removing excess starch from the molded raw materials in the starch removal unit of the starch buck module received from the molding module. After the raw materials are molded into their desired shapes, the filled trays are further transferred to a starch removal unit of the starch buck module for removing excess starch from the raw materials. A cover of the starch removal unit is placed on multiple trays to get tightly fitted on the multiple trays. The method further includes inverting the cover to remove the starch from the trays and further spraying compressed air through the multiple air jets to the gummy puffs adhered to the cover to remove any leftover starch fully from the gummy puffs.

At step 412B, the step includes reconditioning the excess starch removed from the starch buck module. The method includes transferring the excess starch and candy particles to a metal sieve for removing the solid particles, thereby separating the starch from the candy particles. The method further includes reconditioning the excess starch by transferring the same to a re-circulating starch conditioning system. The reconditioning method involves drying the starch by circulating hot air from a drier of the drying unit. The dried starch is further transferred to a cooling unit for reconditioning the starch. The reconditioning method further involves cooling and reconditioning the starch by supplying cool air through multiple air jets of a cooling unit.

At step 414B, the step includes reusing the reconditioned starch by transferring the reconditioned starch to the depositor module.

At step 416B, the step includes stacking and cooling the gummy puffs received from the starch buck module. After the excess starch removed from the gummy puffs, the starch free gummy puffs are transferred to a stacker module. The method includes stacking of the gummy puffs received from the starch removal unit in the stacking module of the mogul unit. The method further includes cooling the stacked gummy puffs transferring them to a cooling room for specific time period. The cooling room stores the gummy puffs for cooling the gummy puffs and storing the gummy puffs till the gummy puffs are transferred for further processing. In one embodiment, the cooling room stores the gummy puffs for 24 hours.

At step 418B, the step includes puffing the cooled gummy candies received from the stacker module. After the gummy candies are cooled enough, the cooled gummy candies are transferred to a puffing unit for puffing the gummy candies. The method includes decreasing the vapor pressure resulting in an increase in surface area of the gummy candies.

At step 420B, the step includes stabilizing the gummy puffs by continuously freezing followed by annealing the gummy puffs received from the puffing unit. After the gummy candies are puffed, the gummy puffs are transferred to a stabilizing unit for stabilizing the gummy puffs. The method includes continuous freezing of the gummy puffs freezing of the gummy puffs at freezing temperatures. More specifically, the temperature range of freezing in the stabilizing unit is −50 C to −80 C. The method further includes annealing of the gummy puffs in the stabilizing unit for restricting formation of large ice crystals in the gummy puffs.

At step 422B, the step includes sublimation of the water molecules within the gummy puffs. After the gummy puffs are stabilized, the stabilized gummy puffs are transferred a primary drying unit for sublimating water molecules within the gummy puffs at a predefined pressure and at a first temperature. The first temperature is calculated on the basis of latent heat of sublimation of the water molecules.

At step 424B, the step includes disintegrating any physio-chemical interactions between the water molecules and the ice crystals to form completely dehydrated gummy puffs. After the gummy puffs are dried in the primary drying unit, the gummy puffs transferred to a secondary drying unit for further dehydrating the gummy puffs. The method includes drying the gummy puffs at second temperature, to disintegrate any physio-chemical interactions between the water molecules and the ice crystals on the gummy puffs, thereby producing completely dehydrated and freeze-dried gummy puffs.

There has thus been shown and described a novel system of producing gummy puffs which fulfills all the objects and advantages sought. Many changes, modifications, variations, and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

Although the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A system for manufacturing gummy puffs, the system comprising:
a) a gummy unit, the gummy unit comprising:
i. a compounding unit for grinding and mixing raw material of gummy puffs;
ii. a mogul unit for receiving the raw materials from the compounding unit, the mogul unit further comprising:
1. a depositor module with a plurality of trays for receiving the raw materials followed by stacking of the plurality of trays;
2. a starch buck module for molding the raw materials received from the plurality of trays and removing excess starch from the raw materials;
3. a stacker module for stacking and cooling the raw materials received from the starch buck module;
b) a freeze-drying unit for receiving the gummy from the stacker module, the freeze drying unit further comprises:
i. a puffing unit for puffing the gummy by lowering the vapor pressure;
ii. a stabilizing unit for stabilizing the gummy by continuously freezing followed by annealing the gummy received from the puffing; and
iii. a drying unit for drying the gummy from the stabilizing unit to form the gummy puffs.

2. The system in accordance with claim 1, wherein the raw materials further comprises pectin.

3. The system in accordance with claim 1, wherein the compounding unit comprises one or more mixing tanks for grinding and mixing the raw material.

4. The system in accordance with claim 1, wherein the depositor module further comprises a nozzle for delivering a pre-defined amount of the raw materials to the plurality of trays.

5. The system in accordance with claim 4, wherein the mogul unit comprises at least thirty depositor modules.

6. The system in accordance with claim 1, wherein the starch buck module comprises:
a) a molding unit for shaping and imprinting the gummy by a board printer; and
b) a starch removing unit for removing excess starch from the gummy.

7. The starch removal unit according to claim 5 further comprises:
a) a metal sieve for sieving the starch from the gummy by vibrating; and
b) a plurality of oscillating brushes connected to the metal sieve for removing leftover starch from the gummy.

8. The starch removal unit according to claim 6, wherein the starch removal unit is a pneumatic starch removal unit.

9. The pneumatic starch removal unit in accordance with claim 8 further comprising:
a cover placed on the plurality of trays to receive the gummy from the depositor module, wherein the gummy adheres to the surface of the cover; and
a plurality of air jets to provide compressed air for removing the starch from the gummy adhered to the cover.

10. The system in accordance with claim 1, wherein the system further comprises a re-circulating starch conditioning system for reconditioning the starch received from the starch removal unit, the re-circulating starch conditioning system further comprising:
a) a drying unit for drying the starch; and
b) a cooling unit including a plurality of air jets for cooling the starch,
further wherein the re-circulating starch conditioning system is connected to the depositor module for reusing the starch.

11. The system in accordance with claim 1, wherein the puffing comprises a preservation formulation revision by addition of preservatives to the gummy puffs for increasing the stability.

12. The system in accordance with claim 1, wherein freezing and annealing restricts the formation of ice crystals in the gummy puffs.

13. The system in accordance with claim 12, wherein the freezing is performed within a temperature range of −50 C to −80 C.

14. The system in accordance with claim 12, wherein the freeze drying unit further comprises:
a primary drying unit at a first temperature, wherein the primary drying unit sublimates water molecules within the gummy puffs at a pre-defined pressure; and
a secondary drying unit at a second temperature lower than the first temperature, wherein the secondary drying unit disintegrates any physio-chemical interactions between the water molecules and the ice crystals.

15. The drying unit in accordance with claim 14, wherein the first temperature is calculated on the basis of latent heat of sublimation of the water molecules.

16. The drying unit in accordance with claim 14, wherein the second temperature is above 0 C.

17. The system in accordance with claim 1, wherein the system further comprises a packaging unit connected with the freeze-drying unit to pack the gummy puffs.

18. A system for manufacturing gummy puffs, the system comprising:
a) a gummy unit, the gummy unit comprising:
i. a grinder assembly for grinding raw material of gummy puffs;
ii. one or more mixers for mixing the raw material received from the grinder assembly;
iii. a mogul unit for receiving the raw material from the one or more mixers, the mogul unit includes:
1. a plurality of depositor modules, wherein each of the plurality of depositor module includes a plurality of trays for receiving the raw material followed by stacking of the plurality of trays;
2. a starch buck module for molding the raw material received from the plurality of trays and removing excess starch from the raw material by a starch removal unit, wherein the starch removal unit includes:
a cover placed on the plurality of trays to receive the raw material from the depositor module, wherein the raw material adheres to the surface of the cover; and
a plurality of air jets to provide compressed air for removing the starch from the raw material adhered to the cover;
3. a stacker module for stacking and cooling the raw material received from the starch buck module;
b) a freeze-drying unit for receiving the raw material from the stacker module, the freeze drying unit comprises:
i. a puffing unit for puffing the gummy by lowering the vapor pressure;
ii. a stabilizing unit for stabilizing the gummy puffs by continuously freezing followed by annealing the gummy puffs received from the puffing unit; and
iii. a drying unit for drying the gummy puffs from the stabilizing unit, wherein the drying unit comprises:
a primary drying unit at a first temperature, wherein the primary drying unit sublimates water molecules within the gummy puffs at a pre-defined pressure; and
a secondary drying unit at a second temperature lower than the first temperature, wherein the secondary drying unit disintegrates any physio-chemical interactions between the water molecules and the ice crystals,
further wherein drying the gummy puffs from the drying unit forms the gummy puffs.

19. The system in accordance with claim 18, wherein the raw materials further comprises pectin.

20. A method of manufacturing dehydrated gummy puffs, the method comprising:
a) mixing raw materials of the gummy puffs in one or more mixers of a compounding unit to form a blended mixture of the raw materials,
b) pouring the blended mixture of the raw materials via a nozzle in a plurality of trays of a depositor module received from the mixers,
c) allowing the blended mixture to settle in plurality of trays of the depositor module,
d) shaping the blended mixture in a molding unit of a starch buck module received from the depositor module,
e) removing excess starch from the molded blended mixture in a starch removal unit by passing compressed air through plurality of air jets on the molded blended mixture, further wherein the molded blended mixture adheres to a cover placed on the molded blended mixture received from the molding unit,
f) stacking and cooling the molded blended mixture received from the starch buck module in a stacking module,
g) puffing the cooled blended mixture by lowering the vapor pressure thereby increasing the surface area of the blended mixture;
h) stabilizing the puffed blended mixture by continuously freezing followed by annealing the puffed blended mixture received from the pre-treatment unit;
i) sublimating water molecules within the puffed blended mixture at a pre-defined pressure and temperature;
j) disintegrating any physio-chemical interactions between the water molecules and the ice crystals, further wherein drying the puffed blended mixture to form the gummy puffs.

21. The method in accordance with claim 20, wherein the raw materials further comprises pectin.

22. A method of manufacturing gummy puffs by using of manufacturing gummy puffs, the method comprises:
a) grinding raw materials of the gummy puffs in a grinder assembly to form grinded raw materials;
b) mixing the grinded raw materials of the gummy puffs received from the grinding assembly in one or more mixers to form a blended mixture of the gummy puffs,
c) pouring the blended mixture of the gummy puffs via a nozzle in a plurality of trays of a depositor module received from the mixers via a conveyor belt,
d) allowing the blended mixture to settle in plurality of trays of the depositor module,
e) shaping the blended mixture filled trays in a molding unit of a starch buck module received from the depositor module,
f) removing excess starch from the molded blended mixture in a starch removal unit by passing compressed air through plurality of air jets on the molded blended mixture, further wherein the blended mixture adheres to a cover placed on the blended mixture filled trays received from the molding unit,
g) reconditioning the excess starch in a re-circulating starch reconditioning system by filtering, drying, and cooling the excess starch received from the starch buck module;
h) reusing the reconditioned starch by transferring the reconditioned starch to the depositor module;
i) stacking and cooling the molded blended mixture in a stacking module received from the starch buck module,
j) puffing the cooled blended mixture by lowering the vapor pressure thereby increasing the surface area of the blended mixture;
k) stabilizing the puffed blended mixture in a stabilizing unit by continuously freezing followed by annealing the puffed blended mixture received from the puffing unit;
l) sublimating water molecules within the puffed blended mixture in a primary drying unit at a pre-defined pressure and temperature received from the stabilizing unit;
m) disintegrating any physio-chemical interactions in a secondary drying unit between the water molecules and the ice crystals received from the primary drying unit, further wherein drying the puffed blended mixture to form the gummy puffs.

23. The method in accordance with claim 22, wherein the raw materials further comprises pectin.
